(19) United States
(12) Patent Application Publication
(10) Pub. No.: US 2010/0042841 A1
(43) Pub. Date: Feb. 18, 2010

(54) Updating and Distributing Encryption Keys

(76) Inventors: Neal King, Munich (DE); Vladimir Oksman, Morganville, NJ (US); Charles Bry, Unterhaching (DE)

Correspondence Address: SLATER & MATSIL LLP, 17950 PRESTON ROAD, SUITE 1000, DALLAS, TX, 75252, US

(21) Appl. No.: 12/192,809

(22) Filed: Aug. 15, 2008

(51) Int. Cl. H04L 9/32; H04L 9/28; H04L 9/30; H04L 9/08

(52) U.S. Cl. 713/171; 380/255; 380/262; 380/283; 380/285

(57) ABSTRACT

System and method for providing secure communications is provided. Initially, an exchange protocol, such as a password-authenticated key exchange protocol, is used to create a shared secret. From the shared secret, two keys are created: a utilized key and a stored key. The utilized key is used to encrypt messages between nodes. When it is time to replace the utilized key to maintain security, the stored key is utilized to encrypt messages for generating/distributing a new shared secret. The new shared secret is then used to generate a new utilized key and a new stored key. This process may be repeated any number of times to maintain security.

### TECHNICAL FIELD

The present invention relates generally to a system and method for providing security to communication networks and, more particularly, to a system and method for generating and distributing encryption keys.

### BACKGROUND

In order to provide confidentiality to communications among nodes of a network, it is well known to provide encryption for the messages. In general, it is best to provide a different encryption key for each pair of communicating nodes, so that the messages of such a pair-wise communication are private to that pair. In this manner, a third node, even if it is exposed to the message (as will generally happen in a network operating on a shared medium), will be unable to decrypt and understand this communication.

The encryption keys, however, must be provided to each pair of nodes before the encryption keys may be used to encrypt communications. It is most important that the encryption keys be provided to the communicating nodes in a secure manner, since if a third node learns the pair's encryption keys, the third node will be able to intercept and decrypt communications between the communicating nodes, thereby violating their privacy. Unfortunately, the most convenient method for exchanging the confidential encryption keys is the network itself.

Accordingly, a first problem with providing secure communications between two nodes is the ability to communicate, over a shared medium, confidential information (such as encryption keys) that enables encryption between two nodes of the network, without that confidential information being made available to other nodes.

A second problem is that even if the confidential information is communicated between nodes without being compromised, the use of the confidential information to encrypt messages over time may allow a third node to derive the confidential information, thereby allowing the third node to intercept and decrypt future communications. The more messages encrypted with a particular key that are sent, the more material becomes available to an attacker attempting to discover the key. Given enough time and material, any encryption system can be broken. It is therefore necessary, from time to time, to replace the encryption keys used by each pair; and this replacement must also be done in a way that preserves confidentiality.

Generally, there are two modes in which an attacker can violate confidentiality. In a passive mode, commonly referred to as “eavesdropping,” the attacker learns the encryption key being used by a pair of nodes, and simply reads the information being passed back and forth.

In another mode, the attacker is able to prevent direct contact between the two nodes of the pair and can interpose itself between them. This can happen, for example, if the two nodes of the pair are in disjoint networks or sub-networks, for which the attacker's node is serving as a relay. In this scenario, every communication from one node to the other node passes through the attacker's node. In that case, if the attacker learns the pair's encryption key, it is possible for the attacker's node to interfere directly in the pair's communications by blocking or altering these communications. This mode is commonly referred to as “playing Man-in-the-Middle” (MitM).

Asymmetric public-key encryption has been used to allow a node A to send a pair-wise key to a second node B. The pair-wise key is encrypted using the public key of node B, which is available to anyone; but it can only be decrypted by using the private key of node B, which only B knows. With the proper selection of public and private keys, the discovery of the private key is rendered computationally infeasible.

A problem with applying this approach is that it is vital that each node have a unique private key—not merely unique within the network, but unique throughout the world. Otherwise, it would be possible for an attacker to learn the private key of target node B by finding another entity that is using the same public key. To prevent this, asymmetric public-key encryption pairs must be purchased and managed.

One attempt to provide secure communications is a symmetric public-key encryption technique. In one example known as the Diffie-Hellman exchange, nodes A and B securely negotiate an encryption key using public messages. Generally, two numbers, p and g, are publicly known as parameters characteristic of the exchange; and each node selects a particular number (e.g., Ra for node A and Rb for node B) that each node uses to derive a value (e.g., g^{Ra} mod p for A and g^{Rb} mod p for B). These derived values are communicated to each other unsecured and unencrypted over the communications network, so that node A knows Ra and g^{Rb} mod p, and node B knows Rb and g^{Ra} mod p. Both node A and node B are then able to calculate the quantity g^{(Ra*Rb)} mod p, which can thus be used in an agreed-upon manner to generate the pair-wise key which is used to encrypt future communications between nodes A and B. A third node, however, that only knows (g^{Ra} mod p) and (g^{Rb} mod p) is not able to calculate the quantity g^{(Ra*Rb)} mod p.

The Diffie-Hellman exchange protocol discussed above is relatively safe against passive eavesdroppers, because of the computational difficulty of solving this so-called “discrete logarithm problem.” A third node will not be able to learn the pair-wise key from simply observing this exchange, even though it is not encrypted. This type of solution, however, may not provide secure communications against a MitM attack.

For example, if a third node, e.g., node C, is serving as a relay node between nodes A and B, node C can play MitM by intercepting messages between nodes A and B. Upon receipt of a message from node A, node C engages in a Diffie-Hellman exchange with node A. Node C also engages in a Diffie-Hellman exchange with node B. Node C can further alter the address-field parameters of packets sent to nodes A and B, so the address of node C does not appear in the packets, and nodes A and B are unaware that communications are being held with node C rather than with each other.

In another attempt, the Diffie-Hellman exchange protocol has been enhanced for protection against the MitM problem. One system is referred to as the password-authenticated key (PAK) exchange protocol. In this protocol, the Diffie-Hellman exchange is conducted with messages that are encrypted by using a password that is known both to node A and to node B, but not to node C. Node C cannot interfere in the exchange between nodes A and B, because node C cannot interpret the exchanged messages.

The price for this safety from a MitM attack is that the password that is shared by nodes A and B must be communicated between them before performing the Diffie-Hellman exchange. Because of the need for complete secrecy of the password, the password should not be communicated over the communications network where it may be intercepted by node C. Often times, this process of distributing the password is slow and inefficient; in general, it should be used only rarely.

Furthermore, although the PAK exchange protocol is safe against a MitM attack, the pair-wise key must still be replaced eventually, since its use creates material for attack. If one were sure that the pair-wise key had not yet been discovered by an attacker, it would be adequate to conduct the normal Diffie-Hellman exchange to generate the new pair-wise key using the current pair-wise key to encrypt messages in the exchange. However, if there were the possibility that the current key had already been discovered, this would not be safe, because the attacker could use the relay node C to step into the exchange and play MitM. The change of key would then not be able to “shake off” node C.

Since one could never really be sure that the key had not been discovered, over the duration of its use, the safe way to proceed is to use the PAK exchange again. However, this also has risks. For example, the encryption provided by multiplying a message by a fixed password is relatively weak, and if the PAK exchange is to be used every time the pair-wise key is replaced, the password itself is at risk of being discovered, because each message sent utilizing the password in the encryption provides more material for an attacker to discover the password itself.

Thus, when using the PAK exchange protocol to set up the pair-wise keys, if one also uses it to replace these keys, there is the risk of exposing the password by over-use. Yet, if one does not use the PAK exchange, but only the Diffie-Hellman exchange unprotected by the password, there is the risk of a node C playing MitM.

Accordingly, there is a need for a system and a method for updating and distributing encryption keys which avoids the two problems described above.

### SUMMARY OF THE INVENTION

These and other problems are generally solved or circumvented, and technical advantages are generally achieved, by preferred embodiments of the present invention which provides a secure system and method for generating and distributing encryption keys.

In accordance with a preferred embodiment of the present invention, a method for providing secure communications is provided. The method includes generating a shared secret known to a first node and a second node. The shared secret is used to generate a utilized key and a stored key. The utilized key is used to encrypt messages between the first node and the second node. At some point, a new shared secret is generated and a new utilized key and a new stored key is derived from the new shared secret. The new utilized key is then used to encrypt further messages.

In accordance with another preferred embodiment of the present invention, a method of communicating with a network node is provided. The method includes generating a shared secret, and generating a first key and a second key based at least in part on the shared secret. Messages are encrypted using the first key. A step of replacing the shared secret, the first key, and the second key is performed. The step of replacing the shared secret includes encrypting one or more messages using the second key.

In accordance with another preferred embodiment of the present invention, a computer program product for providing secure communications is provided. The computer program product includes computer program code for deriving a shared secret, deriving a utilized key and a stored key, and for encrypting messages with the utilized key. When it is time to replace the utilized key for encrypting messages, the computer program product includes computer program code for generating a new shared secret using the stored key to encrypt any messages sent in the process. From the new shared secret, the computer program product includes computer program code for deriving a new utilized key and a new stored key. The new utilized key is used thereafter to encrypt messages.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a network diagram embodying features of the present invention;

FIG. 2 is another network diagram embodying features of the present invention;

FIG. 3 is a flow chart for creating and distributing encryption keys in accordance with an embodiment of the present invention;

FIG. 4 is a message flow diagram for creating and distributing encryption keys in accordance with an embodiment of the present invention;

FIG. 5 is a flow chart for creating and distributing encryption keys in accordance with another embodiment of the present invention; and

FIG. 6 is a message flow diagram for creating and distributing encryption keys in accordance with another embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a pair of nodes communicating with each other. The invention may also be applied, however, to other communications, such as multicasts, broadcasts, or other multi-way communications in which communications are being conducted with several nodes.

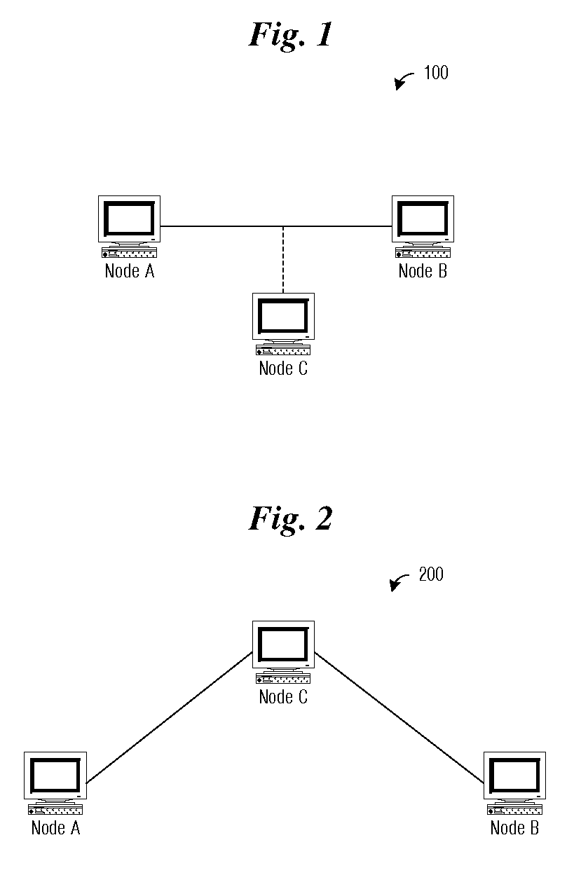

With reference now to FIG. 1, there is shown a network environment 100 embodying features of the present invention. In the network environment 100, node A communicates directly with node B. It should be noted that node A and node B are illustrated as being directly connected for illustrative purposes only. In this scenario, nodes A and B are communicatively coupled to the same network/sub-network such that communications between node A and node B are essentially sent directly between each other. The network may include, for example, a local-area network (LAN) and/or a wide-area network (WAN), and may include wired and/or wireless links, the Public-Switched Telephone Network (PSTN), wireless communications network, or the like.

This type of network environment is subject to passive attacks, e.g., eavesdropping, but it relatively safe from MitM attacks because a network/sub-network does not act as a relay point for communications between nodes A and B. A passive attack is illustrated in FIG. 1 by node C and the dotted line. Node C may simply be another node on the same network/sub-network as nodes A and B such that node C may monitor the traffic on the communications link between nodes A and B.

FIG. 2 illustrates a network environment 200 embodying features of the present invention. The network environment 200 is similar to the network environment 100, except that in this situation all communications between nodes A and B are relayed by node C. This scenario may occur in situations in which nodes A and B are not in the same network or sub-network. Messages sent from node A to node B are first sent to node C. Node C evaluates the addressing info in the packets and forwards the messages to node B. Accordingly, while this situation lends itself to MitM attacks, embodiments of the present invention as discussed in greater detail below provide a mechanism to reduce the probability of a MitM attack, if not to prevent it altogether.

It should be noted that, unless indicated otherwise, all functions described herein may be performed in either hardware or software, or some combination thereof. In a preferred embodiment, however, the methods described below are performed by node A and/or node B, thereby providing secure communications therebetween. Preferably, nodes A and B include functions performed by a processor such as a computer or an electronic data processor in accordance with code such as computer program code, software, and/or integrated circuits that are coded to perform such functions, unless indicated otherwise. The nodes may be, for example, any electronic device such as a personal computer, a wireless device, a cell phone, a mainframe computer, or the like.

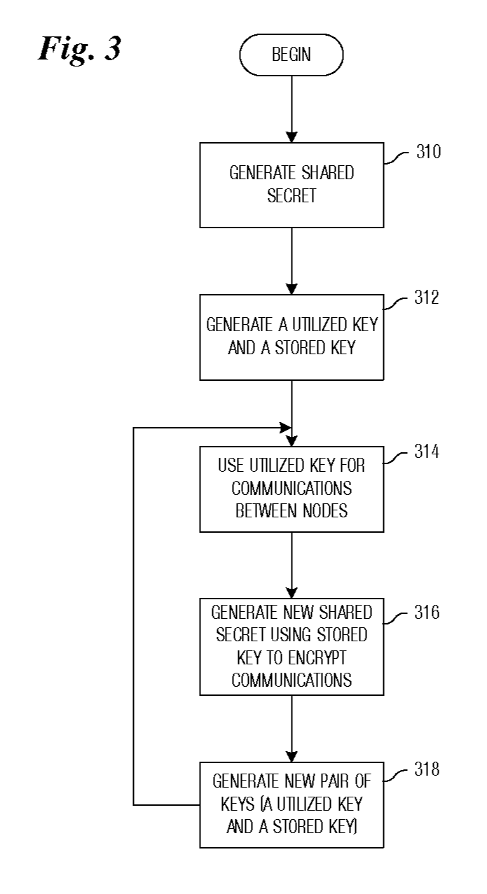

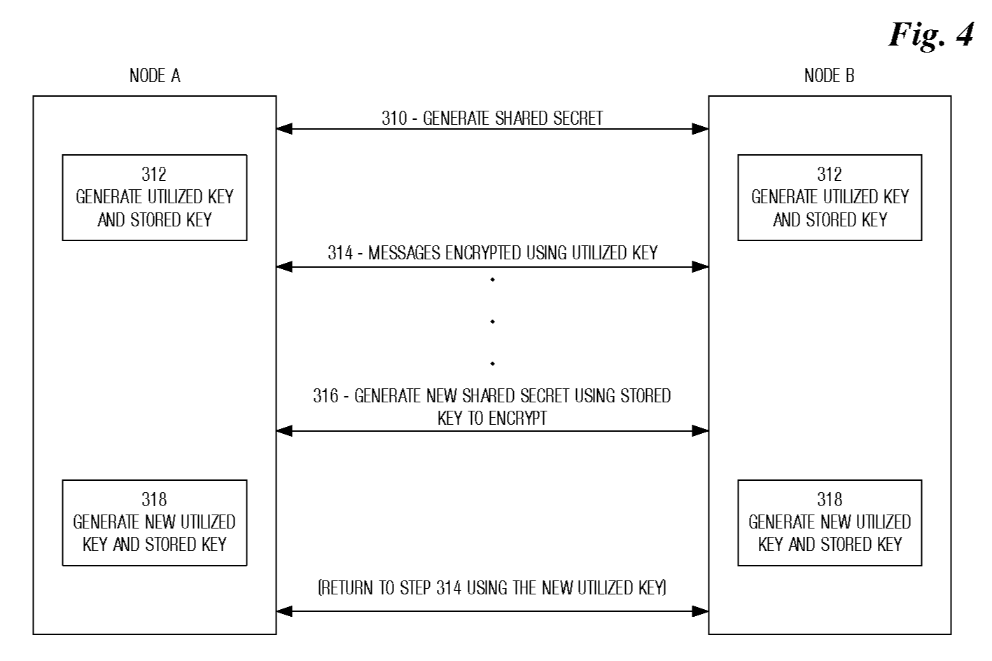

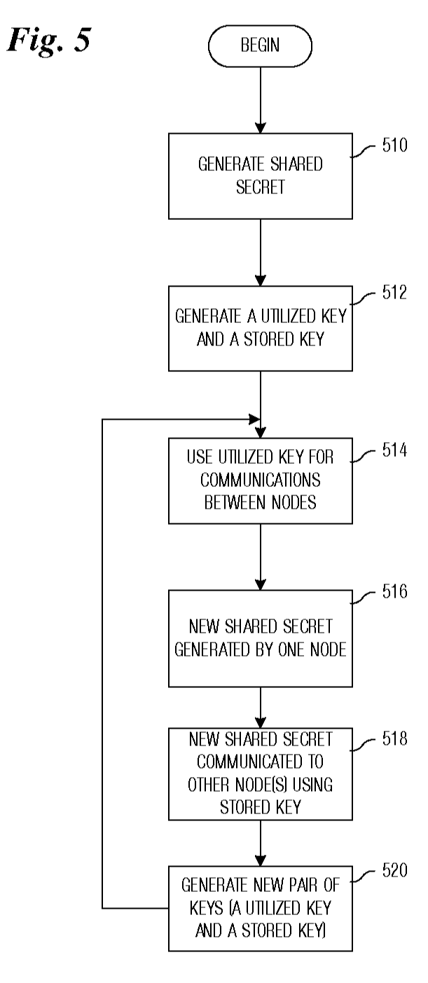

FIGS. 3 and 4 illustrate a method of performing an embodiment of the present invention, wherein FIG. 3 is a flow chart and FIG. 4 illustrates the steps of the flow chart in the context of communications between nodes A and B for further illustration. The process begins in step 310, wherein a shared secret is generated. In an embodiment, the shared secret is generated in dependence on a password that is known only to the communicating nodes, such as nodes A and B. The password may be communicated from one node to the other off-line, or it could be entered via a local communication interface such as USB or Bluetooth. Preferably, however, the password is not communicated over the network. In reliance on the secrecy of the password, the shared secret is generated using a secure exchange protocol, such as PAK exchange protocol communicated via network communications. The use of an exchange protocol, such as PAK, allows for the easy, quick, and efficient generation of a shared secret, while providing protection from eavesdropping as well as MitM attacks. Other protocols and/or mechanisms, however, may be utilized.

Next, a utilized key and a stored key are derived from the shared secret. The utilized key is used immediately for encrypting communications between node A and node B, while the stored key is saved for use later to generate a new shared secret as discussed in greater detail below. It should be noted that in the preferred embodiment, the password and the first shared secret are not utilized for communications after the utilized key and the stored key are generated.

The utilized key and the stored key may be derived by any suitable mechanism as long as it is computationally infeasible to determine the stored key on the basis of knowing only the utilized key. For example, in one embodiment, the utilized key and the stored key are derived by pre-arranging the use of two different functions using the shared secret as the input. The two functions may be, for example, two independent cryptographic hash functions, the outputs of which are fixed-size strings that are computationally impractical to reverse-map. In this manner, the shared secret, and hence the stored key, cannot be uncovered by a third party even if the utilized key is discovered.

As another example, the newly-generated shared secret can be used as a key to encrypt messages to conduct another exchange protocol, such as Diffie-Hellman exchange, to generate the two new keys. In order to increase the difficulty, two consecutive exchanges could be used, one for each key.

As yet another example, the newly-generated shared secret can be used as a password in an authenticated exchange protocol, e.g., another PAK exchange, to generate new keys. As discussed above, authentication exchange protocols such as PAK adds another level of protection, particularly against MitM attacks. In order to increase difficulty, two consecutive exchanges could be used, one for each key.

As yet another example, one node can autonomously generate two new keys and transmit the two new keys to the other node using the shared secret as an encryption key. For example, after the shared secret is derived in step 310, node A can autonomously generate the utilized key and the stored key. Node A can then encrypt the utilized key and the stored key using the newly-created shared secret as an encryption key. After encrypting, node A transmits the encrypted utilized key and stored key to node B. Thereafter, nodes A and B can communicate securely using the utilized key as an encryption key. In this approach, however, an attacker having insight into the mechanism by which node A is generating the utilized key and the stored key may create a security breach, making this method less desirable than using one of the other approaches.

As illustrated in step 314, the utilized key is used to encrypt communications between the nodes.

At some point, it is desirable to replace the utilized key as illustrated in step 316. As discussed above, the more the utilized key is used in communications, the more information is available to an attacker, and the greater the probability that the attacker will be able to derive the utilized key. Accordingly, it is desirable that the utilized key be replaced from time to time.

Replacing the utilized key, however, is different than the initial exchange because nodes A and B already have a key unknown to an attacker, i.e., the stored key. Accordingly, by using the stored key to encrypt messages during an exchange protocol, an algorithmically more robust form of security can be provided.

It should be appreciated that because the stored key has not been previously used, an attacker has no material available to attempt to derive the stored key. The use of the stored key to encrypt communications to replace the utilized key will be the first use of the stored key. Therefore, even if the utilized key has already been discovered by the attacker, it will still be impossible for node C to either eavesdrop or play MitM when the stored key is used. Furthermore, because the stored key does not employ the password used in the initial exchange, e.g., the initial PAK exchange, the use of the stored key does not entail any additional exposure of the password. The cryptographic protection of this replacement process is stronger than the cryptographic protection of the initial exchange to generate the first shared secret, because the computation required to test each guess at the key can be much greater, depending on the specific encryption algorithm employed, than it would have been to test each guess at the password.

In an embodiment, a Diffie-Hellman exchange protocol may be used such that the messages are encrypted using the stored key. As a result of the Diffie-Hellman exchange protocol, a new shared secret known only to nodes A and B is generated. In other embodiments, other exchange protocols may be used.

Next, in step 318, a new utilized key and a new stored key is derived from the new shared secret generated in step 316. The same mechanisms may be used to generate the new utilized and stored keys as discussed above with reference to step 312. The generation of the new utilized key and the new stored key may use the same mechanism or a different mechanism from the mechanism used to generate the first utilized key and the first stored key (step 312).

Thereafter, the process returns to step 314, wherein the new utilized key is used for communications between nodes. At some point, the new utilized key may be replaced with yet another utilized key. The process may be repeated as many times and as often as desired.

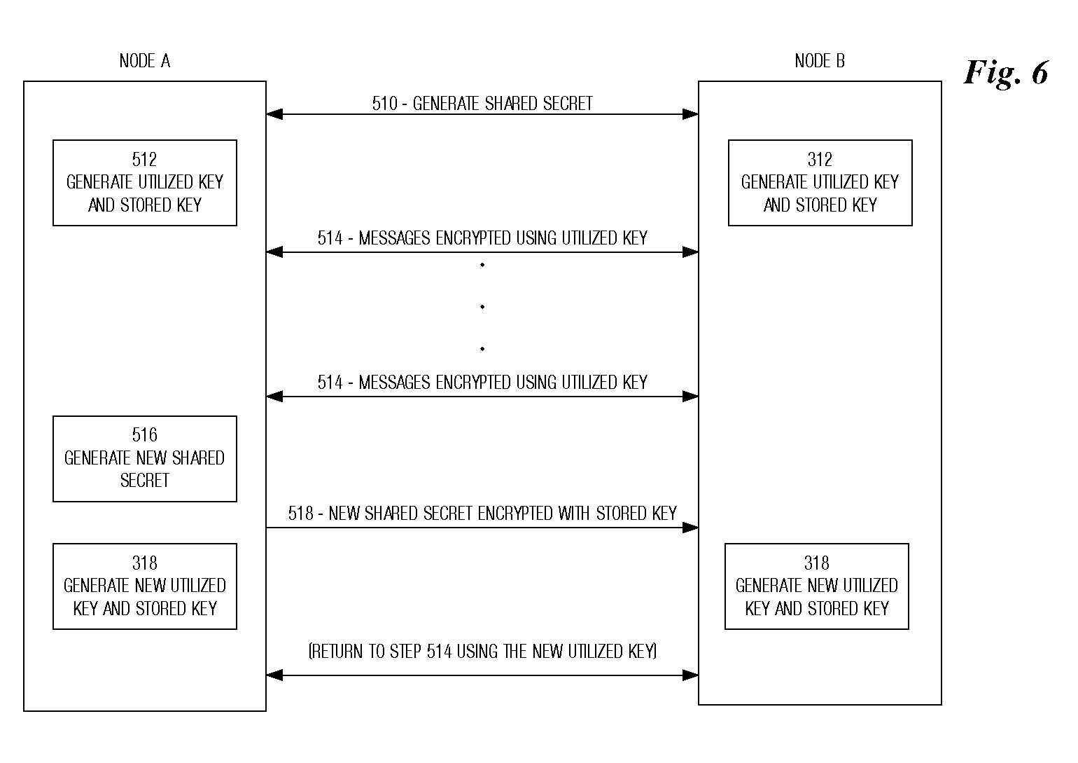

FIGS. 5 and 6 illustrate steps in an alternative embodiment of the present invention, wherein FIG. 5 illustrates steps in a flow chart and FIG. 6 illustrates steps in the context of messages sent between nodes A and B. The method begins in steps 510 and 512, wherein a shared secret is determined and shared between nodes A and B, and a utilized key and a stored key is generated, respectively. Steps 510 and 512 may be performed similarly to step 310 and 312, respectively, as discussed above with reference to FIG. 3. In step 514, similar to step 314 of FIG. 3, the utilized key is used for secure communications between nodes A and B.

Next, in step 516, one of the communicating nodes generates a new shared secret. For example, node A may generate a new shared secret using any suitable technique. It should be noted that either node may generate the new shared secret based on some parameter, such as use, time, access, or the like. It is also contemplated that the node generating the new shared secret may be pre-arranged to be a particular node, alternating between nodes, both nodes, or the like. One of ordinary skill in the art will realize that the methods described herein may be automated and carried out with little or no overhead and intervention, thereby allowing frequent (and secure) changes of the utilized key.

The new shared secret is encrypted using the stored key and communicated to the other node(s) in step 518. Because the stored key has yet to be used, it is highly improbable that a third party may derive the stored key even if the utilized key has been discovered.

Thereafter, in step 520, a new utilized key and a new stored key are derived from the new shared secret. The new utilized key and stored key may be derived in a similar manner as discussed above with reference to step 320 of FIG. 3. Thereafter, the process returns to step 514, wherein the new utilized key is used for communications between nodes. At some point, the new utilized key may be replaced with yet another utilized key. The process may be repeated as many times and as often as desired.

This method illustrated in FIGS. 5 and 6 uses fewer message exchanges than the method of FIGS. 3 and 4, and is easily generalized for distributing keys to protect multicast communications.

It should be appreciated that, when the stored key is used for the replacement transaction, even if node C had already succeeded in discovering the utilized key, node C would not know the stored key, so node C would not be able to interfere in the replacement. Even if node C had been acting as MitM, it would be “shaken off” when the utilized key is replaced.

Furthermore, unlike in the PAK exchange protocol, the password is not used after the first utilized and stored keys are derived, thereby providing no additional material to an attacker. Rather, the stored key is used to exchange and share, e.g., via the Diffie-Hellman exchange, other secrets to derive a new utilized key and a new stored key. Even if the utilized key were to be discovered by an attacker, the stored key would still be unknown.

It should be noted that care should be taken to ensure that communication can take place during the key-replacement process. In particular, if two nodes are engaged in a data-transfer communication during the same period in which the utilized key is being replaced, it may be necessary to agree upon which key is used for each message, so that the two separate streams of communication are not confused. One approach is to identify each key with a number that is displayed on each message. Another approach is for the two nodes to negotiate a message-sequence number for the change of key. In order to increase the difficulty for a successful attack, this message-sequence negotiation can be encrypted with the current utilized key.

Furthermore, it may be desirable to provide end-to-end encryption not just for the communications between one node and another, but between two applications which are served at these two nodes. The methods described in this teaching can easily be generalized to cover this case. For example, if ten keys are needed for application-level encryption, at the time the utilized and stored node-level keys are created, the shared secret can also be used as input to generate ten utilized and stored application-level keys, by a method that is known to both sides. Provided it is computationally infeasible to invert this method, the security provided by the protocol is extended to the application level without significant extra effort.

Embodiments of the present invention may be utilized in any type of communications over a network. In one particular embodiment, the techniques discussed herein are utilized to perform secure communications in a home network, in which the nodes of the home network are joined by wired and/or wireless links. Such a network may be made up of sub-networks with each node within a sub-network communicating directly with the other nodes of the sub-network using the shared medium. Home networks may also allow a node in one sub-network to communicate with a node in a different sub-network by depending on one or more relay nodes. Thus, the issue of MitM interference is of interest as well.

One environment in which embodiments of the present invention may be particularly useful is described in U.S. patent application Ser. No. 12/164,792, filed on Jun. 30, 2008, by Vladimir Oksman, Neal King, and Charles Bry (Atty. Dock. No. 2008P50985US) (hereinafter “Oksman”), which is incorporated herein by reference. A security controller (SC) function resides on one node that possesses all passwords needed to set up communications with each of the nodes of the network. Using the password for each node, the SC sets up a key for node-to-SC encrypted communication (the NSC key) for each node. The SC then uses the NSC keys to manage or facilitate the creation of keys for node-to-node encrypted pair-wise communication (the NN keys). The set of NN keys applicable for each node are encrypted by the SC using the NSC key for that respective node and sent to it.

Techniques described herein may be used to enhance the method of creating and distributing the keys among the SC and the other nodes in any or all of these situations. For example, if the SC resides in node A and the NSC key for node B is to be created, the techniques described above can be applied to create stored and utilized NSC keys for mode B. Replacements of the NSC keys can be conducted repeatedly without the risk of further exposing the passwords. With regard to the NN keys, the methods described above may be used to allow the nodes to replace the NN keys as described above by direct node-to-node messages, without any intervention by the SC.

Oksman further describes a method in which the nodes generate NN keys using the SC as an intermediary. A requester node sends messages encrypted by the NSC key for node D to the SC, which decrypts the messages. The SC then encrypts the messages with the NSC key for an addressee node and sends the result to the addressee node. In this way, the requester node and the addressee node co-generate a shared secret.

In this situation, by using the SC as a relay and translator, a shared secret co-generated by the requester and the addressee may be used to create a utilized key and a stored key. In this case, however, rather than using the PAK exchange protocol for the initial generation of keys, a simpler Diffie-Hellman exchange may be used (e.g., no password). The exchange messages will be encrypted by using the NSC key for the requester node (for the requester-to-SC messages) and by the NSC key for the addressee node (for the SC-to-addressee messages). In this scheme, MitM is not possible unless one of these keys has been discovered. Thereafter, key replacement (creating new stored and utilized NN keys) may be done without using the SC as an intermediary, since the requester and addressee nodes can now communicate directly.

A system of transmitting multi-cast messages (e.g., messages from a specific source node R to a group of nodes Addressee 1, Addressee 2, etc.) is also described in Oksman. The source node R transmits a multicast node-to-node key (MNN key) to the SC using the NSC key of node R. The SC individually encrypts messages to each of the addressed nodes conveying the MNN key to each node using the NSC key of each respective node.

In the context of the present teaching, instead of conveying the MNN key itself, the individually encrypted messages will convey a secret that will be used to generate two keys: the stored MNN key and the utilized MNN key. When the MNN key is to be replaced, this can be done by direct multicast from node R to the addressed nodes, using the stored MNN key. The intermediary function of the SC is not needed for MNN key replacement.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing secure communications, the method comprising:
generating a shared secret known to a first node and a second node;
generating a utilized key and a stored key from the shared secret;
using the utilized key to encrypt messages between the first node and the second node;
generating a new shared secret known to the first node and the second node; and
deriving a new utilized key and stored key.

2. The method of claim 1, wherein the shared secret is generated using at least in part a password-authenticated key (PAK) exchange protocol.

3. The method of claim 1, wherein the generating the new shared secret is performed at least in part using a Diffie-Hellman exchange protocol.

4. The method of claim 3, wherein communications of the Diffie-Hellman exchange protocol are encrypted using the stored key.

5. The method of claim 1, wherein the new shared secret is generated by one of the first node and the second node.

6. The method of claim 5, further comprising communicating the new shared secret to the other of the first node and the second node using the stored key.

7. The method of claim 1, wherein the generating the new shared secret includes encrypting one or more messages with the stored key.

8. A method of communicating securely with a network node, the method comprising:
(a) generating a shared secret;
(b) generating a first key and a second key, the first key and the second key being based at least in part on the shared secret;
(c) encrypting one or more messages using at least the first key;
(d) replacing the shared secret, the replacing the shared secret including encrypting one or more messages using at least the second key; and
(e) re-generating the first key and the second key based at least in part on the replaced shared secret.

9. The method of claim 8, further comprising repeating steps (c)-(e) a plurality of times.

10. The method of claim 8, wherein step (a) is performed at least in part using a password authenticated key exchange protocol.

11. The method of claim 8, wherein step (d) is performed at least in part using a Diffie-Hellman exchange protocol.

12. The method of claim 8, further comprising sending the shared secret to another node after the step of the replacing the shared secret.

13. The method of claim 12, wherein the sending includes encrypting the shared secret with the second key.

14. The method of claim 8, wherein step (b) is performed at least in part by using one or more key-exchange protocols.

15. The method of claim 14, wherein messages sent during the one or more key-exchange protocols are encrypted using the shared secret.

16. A computer program product for providing secure communications, the computer program product having a medium with a computer program embodied thereon, the computer program comprising:
computer program code for deriving a shared secret;
computer program code for deriving a utilized key and a stored key;
computer program code for encrypting messages with the utilized key;
computer program code for generating a new shared secret, the computer program code for generating a new shared secret including computer program code for sending at least one message encrypted with the stored key;
computer program code for deriving a new utilized key and a new stored key from the new shared secret; and
computer program code for encrypting messages with the new utilized key.

17. The computer program product of claim 16, wherein the computer program code for generating a new shared secret includes computer program code for generating the new shared secret, for encrypting the new shared secret using the stored key, and for sending the encrypted new shared secret.

18. The computer program product of claim 16, wherein the computer program code for deriving a new shared secret includes computer program code for performing one or more Diffie-Helman exchanges, messages of the Diffie-Hellman exchanges being encrypted using the stored key.

19. The computer program product of claim 16, further comprising computer program code for sending the new utilized key and the new stored key to another node, the new utilized key and the new stored key being encrypted.

20. The computer program product of claim 16, wherein the computer program code for deriving the shared secret includes computer program code to perform a password-authenticated key (PAK) exchange.
